(19) United States
(12) Patent Application Publication
(10) Pub. No.: US 2020/0291765 A1
(43) Pub. Date: Sep. 17, 2020

(54) DOWNHOLE TOOL DIAGNOSTICS

(71) Applicant: Halliburton Energy Services, Inc., Houston, TX (US)

(72) Inventors: Reena Agarwal Chanpura, Sugar Land, TX (US); Rajeev Ghimire, Spring, TX (US); Kimberly Reardon, Houston, TX (US)

(21) Appl. No.: 16/655,758

(22) Filed: Oct. 17, 2019

Related U.S. Application Data
(60) Provisional application No. 62/819,144, filed on Mar. 15, 2019.

(51) Int. Cl. E21B 47/00; G01M 99/00

(52) U.S. Cl. CPC E21B 47/00; G01M 99/008

(57) ABSTRACT

A method for performing diagnostics of a downhole tool during a downhole operation includes generating a System of System (SoS) dataset in a time domain and a depth domain for the downhole tool, wherein the SoS dataset comprises operational mode data associated with different operational modes of the downhole tool and tool mode data associated with different tool modes of the downhole tool. The method includes combining the operational mode data with the tool mode data to create a combined data and generating anomaly codes associated with failures of the downhole tool based on the combined data. The method includes generating a tool fault model based on cause and effect dependencies and the anomaly codes and determining a failure and a cause of the failure of the downhole tool during the downhole operation based on the tool fault model.

### BACKGROUND

The disclosure generally relates to the field of hydrocarbon recovery operations, and more particularly to downhole tools diagnostics.

Various downhole tools are used for hydrocarbon exploration and production. Such tools can include rotary steerable system (RSS) tools, measurement while drilling (MWD) tools, logging while drilling (LWD), wirelines tools, etc. Such tools may operate in severe conditions including high downhole temperatures and pressures that may impact the tools and systems in which the tools operate.

### BRIEF DESCRIPTION OF THE DRAWINGS

Embodiments of the disclosure may be better understood by referencing the accompanying drawings.

FIGS. 1A and 1B are conceptual, partial cutaway diagrams depicting an example drilling system and an example wireline system that may implement aspects of a downhole tool diagnostics system, according to some embodiments.

FIGS. 2-3 are flowcharts illustrating operations and functions for implementing downhole tool diagnostics, according to some embodiments.

FIG. 4 is a flowchart depicting operations and functions for generating a System of Systems (SoS) dataset, according to some embodiments.

FIGS. 5-6 are flowcharts illustrating operations and functions for generating anomaly codes, according to some embodiments.

FIG. 7 is a flowchart depicting operations and functions for generating anomaly codes based on tiered filtering, according to some embodiments.

FIG. 8 is a flowchart illustrating operations and function for flagging anomaly codes based on theoretical residuals, according to some embodiments.

FIG. 9 is a flowchart depicting operations and functions for implementing Rotary Steering System diagnostics, according to some embodiments.

FIG. 10 depicts a list of example anomaly codes, according to some embodiments.

FIG. 11 depicts an example Graphical User Interface (GUI) of failure/suspect isolation based on example anomaly codes of FIG. 10, according to some embodiments.

FIG. 12, depicts example plots based on the example anomaly codes of FIG. 10 and GUI of FIG. 11, according to some embodiments.

FIG. 13 depicts an example computer, according to some embodiments.

### DESCRIPTION

The description that follows includes example systems, methods, techniques, and program flows that embody aspects of the disclosure. However, it is understood that this disclosure may be practiced without these specific details. For instance, this disclosure describes diagnostics for a Rotary Steerable System (RSS) in some embodiments. Aspects of this disclosure may be also applied to any other type of downhole tool during or subsequent to drilling operations. For example, some embodiments may be used for diagnostics of Measurement While Drilling (MWD) tools, Logging While Drilling (LWD) tools, wireline tools, etc. In other instances, well-known instruction instances, protocols, structures, and techniques have not been shown in detail in order not to obfuscate the description.

A system of systems (SoS) is a set of two or more systems having respective individual operational profiles and that collectively may be generally characterized in terms of operational data associated with different operational modes and interoperability of a SoS. Some embodiments include a closed-loop automated diagnostic system using SoS data analytics, and fault model-based diagnostics to assess the operational condition of a RSS. A SoS may comprise rig site surface elements, mud system, wellbore, drill pipe and bottom hole assembly (BHA) elements. Such embodiments enable (1) accurate decision to re-run the RSS tool in the field without maintenance; (2) fault model-based fail-site isolation and guided troubleshooting within the RSS for repair and maintenance which would aid in minimizing mean time to repair and repair cost; and (3) identify enabling systems and other element failures determined by the SoS data modeling and analytics that can manifest as RSS functional failures to facilitate accurate root cause analysis at the BHA level. SoS data analytics can include rig site surface data, mud data, real time data, downhole recorded data from BHA elements, etc.

In some embodiments, a master SoS dataset in time and depth domain is generated. The SoS data can be analyzed by combining operational modes (e.g., pumps on/off, drilling activity, etc.) with tool modes (e.g., geostationary vs neutral, state machine, etc.) to generate anomaly codes or observations pre-defined for the system of interest and the SoS. Different or tiered filtering can be applied to the same signals to flag anomaly codes that help narrow fail-site isolation region. Different downhole measurements located within close proximity to each other can be used with theoretical models to compute operational parameters. Also, residuals of the theoretically computed operational parameters can be used to flag anomaly codes. Some embodiments can compare BHA bus master broadcast versus applied measurements to select signals to determine communication issues or identify logical errors.

Fault models can be developed based on cause and effect dependencies derived from tool architecture, design documents, test-bed experiments, accumulated information, physics-based/data-driven models, and SoS elements. Also, a library of anomaly codes corresponding to fault model observations can be defined. Anomaly codes are flagged when an anomaly is observed from the expected behavior under specified conditions. Algorithms can be developed to log the anomaly codes based on data from the tool of interest (e.g., RSS) and other parameters from the SoS dataset. The anomaly codes log can be used as input to the fault model to determine the possible suspects/failures within the system. In some embodiments, specific plots, charts, and statistics with relevant signals can be generated and displayed based on anomaly codes and suspects lists for guided troubleshooting. A library of plot templates for anomaly codes based on possible failure causes can be built.

Templates can include specific signals to be analyzed and displayed in graphical form. Reference graphs can be provided to spot anomalies and disposition appropriately. Plot and statistic generation can be automated using a pre-defined mapping logic between anomaly codes and the plots listed in the plot libraries. Also, failures/suspects generated from fault model and anomaly code logs that require repair and maintenance of the downhole tool can be classified based on functions (e.g., power on different voltage levels, communication, sensors, etc.) and sub-systems/modules. In some embodiments, accurate health assessment and re-run criteria for a downhole tool can be determined at the rig site.

If no anomaly codes are flagged, preventive maintenance (PM) can be performed based on PM triggers. In some embodiments, if anomaly codes for secondary functions are flagged, the downhole tool may continue operation without repair if legacy based redundant tools are used for the secondary functions, or if service is delivered without the secondary functions, and if no preventive maintenance triggers are flagged for primary or critical functionality. If anomaly codes for primary or critical functionality are flagged, the fault model can be used with the anomaly code logs to provide fault isolation to the classified level along with troubleshooting guidelines. In addition, the anomaly codes list can be updated with post run shop level test observations. The downhole and shop observed fault codes and the fault model can be used to obtain the fault diagnostic results and provide troubleshooting guidelines to further isolate the failure.

Some embodiments combine operational and tool modes with tiered filtering of the SoS dataset to flag anomaly codes correctly, minimize false positives, and narrow down the failure suspects. For example, anomaly codes for valve toolface control (motor status, active rectification, and flow based) and power (flow and state machine based) use tiered filtering approach. Different downhole measurements located within close proximity along with test based/physics-based models can be used to compute operational parameters. Also, residuals of operational parameters can be used to flag anomaly codes and assess health of different sub-assemblies or components of the downhole tool.

Anomaly codes can be analyzed and failure suspects classified by functions and/or modules. Additionally, some embodiments provide flexibility to re-run the tool in the field without repair if only noncritical or secondary functional anomaly codes are flagged. Suspects can be classified based on function (e.g., power generation (high voltage or low voltage), communications, downlink, valve tool face (TF), control sensors (e.g., gamma, directional, etc.), and/or modules like alternator assembly, sonde etc.

Some embodiments include SoS data analytics to accurately identify enabling or other systems defects that manifest as a failure of the tool of interest (e.g., RSS) for fast and accurate root cause analysis. An enabling system is an element in the SoS that enables primary or secondary functionality of a downhole tool. For example, if the RSS tool generates power using a turbine assembly, then a mud flow system utilized by the turbine assembly is an enabling system for the RSS tool. Some of the enabling system or BHA element failures that can appear as RSS failure include but are not limited to (1) intermittent or hard inter-connect failures between BHA tools or elements resulting in lost communications, and (2) surface valve stuck open, wash out in one of the BHA elements, and/or reduced flow in a Motor Assist Rotary Steerable System (MARSS) application resulting in turbine based power generation failures, etc.

Thus, some embodiments enable fast and accurate decisions at the rig and provide guided troubleshooting to reduce repair time and repair cost in the event of a failure for the downhole tools. Some embodiments can include automated diagnostics based on SoS data analytics and a fault model approach for a downhole tool to facilitate: (1) accurate decisions to re-run the downhole tool in the field without maintenance, resulting in reduced nonproductive time and improved asset utilization; (2) identification of SoS failures that manifest as downhole tool functional failure to facilitate accurate root cause analysis at the BHA level; and (3) guided troubleshooting to reduce repair time and repair cost associated with corrective maintenance. Additionally, some embodiments include use of automated diagnostics along with shop level checks for fast and accurate full tool check out pass/fail assessment prior to tool shipment to the rig. Also, some embodiments include an automated diagnostic approach that can be used for any downhole tool (MWD tools, LWD tools, wireline tools, etc.).

### Example Drilling System

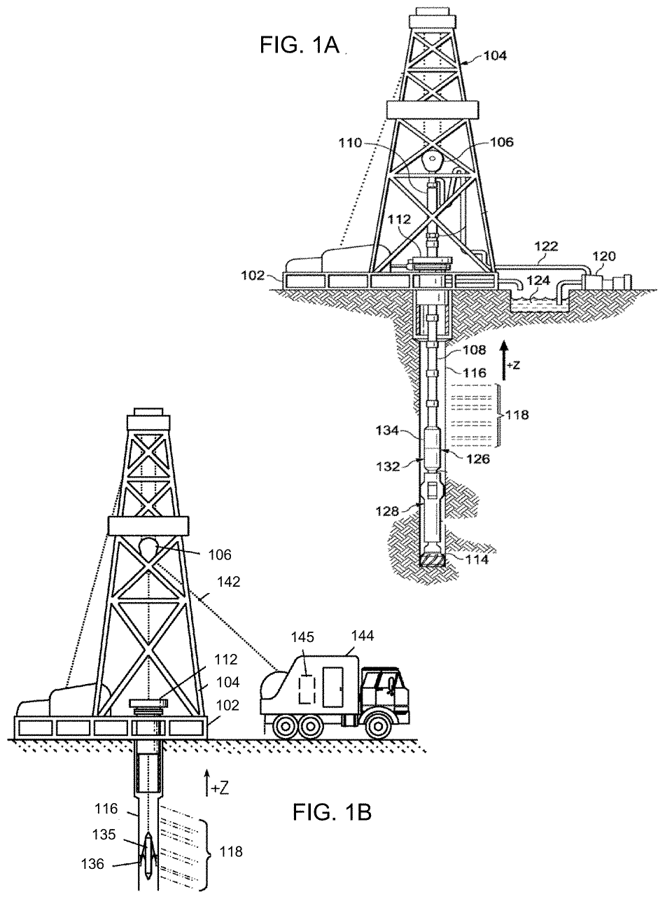

FIG. 1 depicts an example drilling system, according to some embodiments. In FIG. 1, a tool string 126 disposed in a borehole 116. The tool string 126 including a rotary steerable system (RSS) 128 in accordance with various embodiments. A drilling platform 102 supports a derrick 104 having a traveling block 106 for raising and lowering a drill string 108. A kelly 110 supports the drill string 108 as it is lowered through a rotary table 112. In some embodiments, a topdrive is used in place of the kelly 110 and the rotary table 112. A drill bit 114 is driven by a downhole motor or RSS, and/or rotation of the drill string 108. As bit 114 rotates, it creates the borehole 116 that passes through various downhole strata 118. A pump 120 circulates drilling fluid through a feed pipe 122 and downhole through the interior of drill string 108, through orifices in drill bit 114, back to the surface via the annulus around drill string 108, and into a retention pit 124. The drilling fluid transports cuttings from the borehole into the pit 124 and aids in maintaining the borehole integrity.

Tool string 126 includes RSS 128 and a compass unit 132. Compass unit 132 is a direction determination component that may be a sub or a component of sub (e.g., a MWD sub) disposed in the tool string 126 at a location that allows accurate directional determination such as by determining the angle between magnetic north and a reference location of the compass unit 132. In some embodiments, RSS 128 includes the direction control system that computes a target tool face or target position command based on the measurements provided by the RSS directional control sensors and compass unit 132. Tool string 126 may also include a logging-while-drilling (“LWD”)/measurement-while-drilling (“MWD”) tool 134 that collects measurements relating to various formation properties as well as the bit position and various other drilling conditions as bit 114 extends borehole 116 through the downhole strata 118. A telemetry system may be included to transfer tool measurements to and receive commands from a control/processing system located at the surface.

At various times during the drilling process, drill string 108 is removed from borehole 116 as shown in FIG. 1B. Once the drill string has been removed, logging operations may be performed using a wireline logging tool 135, which in the depicted embodiment may be a sensing instrument sonde suspended by a cable 142 having conductors for transporting power to logging tool 135 and communications from logging tool 135 to the surface. For example logging tool 135 may comprise sensors for measuring downhole materials properties such as resistivity of and may have centralizing arms 136 that center logging tool 135 within borehole 116. A logging facility 144 collects measurements from the wireline logging tool 135 and includes computing facilities 145 for processing and storing the measurements gathered by wireline logging tool 135.

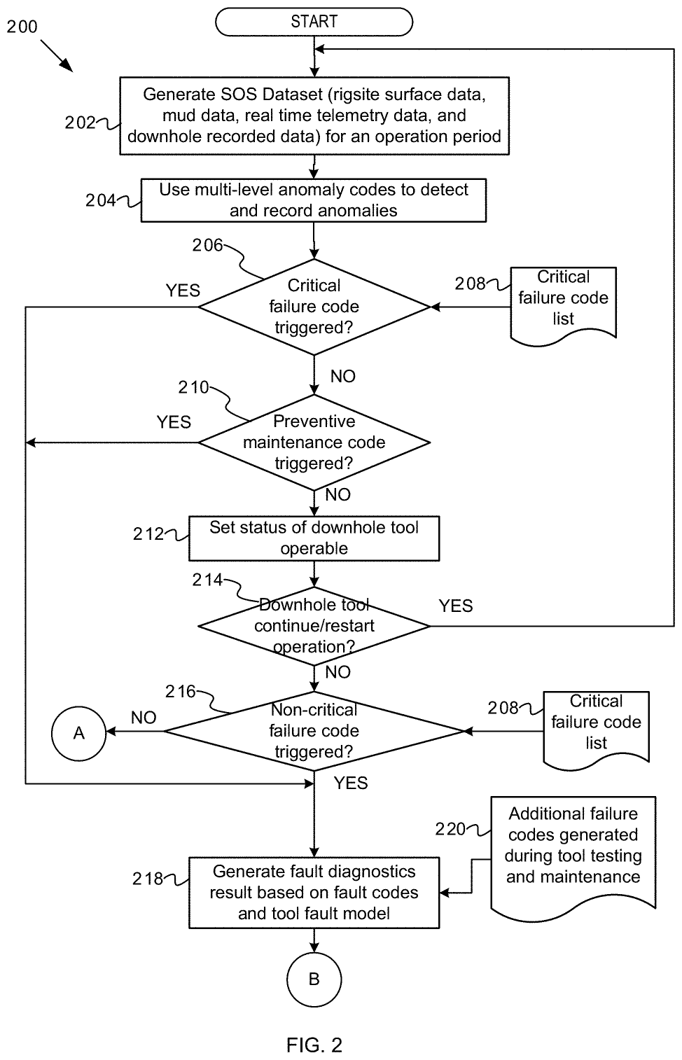

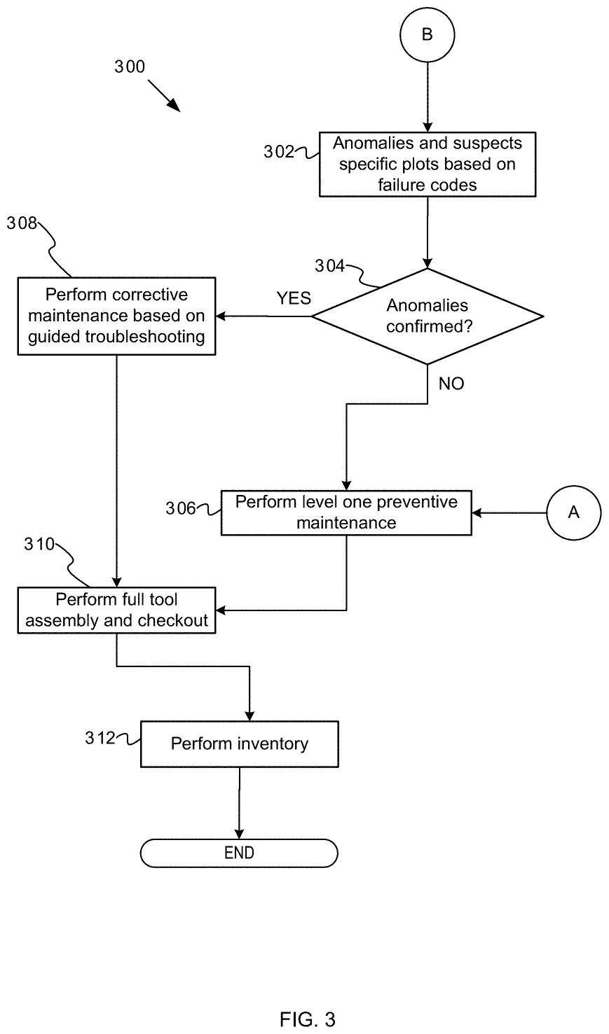

Example downhole tool diagnostics operations that may be implemented in association with the drilling system and wireline system components depicted in FIGS. 1A and 1B are now described. FIGS. 2-3 are flowcharts 200 and 300 illustrating operations and functions for implementing downhole tool diagnostics, according to some embodiments. The downhole tool diagnostics operations and functions continue from FIG. 2 to FIG. 3 through transition points A and B. The operations and functions depicted in flowcharts 200-300 may be performed by a combination of electrical, mechanical, and electromechanical components such as system sensors implemented in to measure operating parameters of surface and downhole drilling system components. Such sensors may be implemented locally downhole and may include sensors within LWD/MWD tool 134 or logging tool 135. The sensors may be implemented downhole, for example, to monitor various components within RSS 128 and drill bit 114. The sensors may also be implemented on surface components such as surface drill string control components and components that form part of the drilling fluid system such as pump 120.

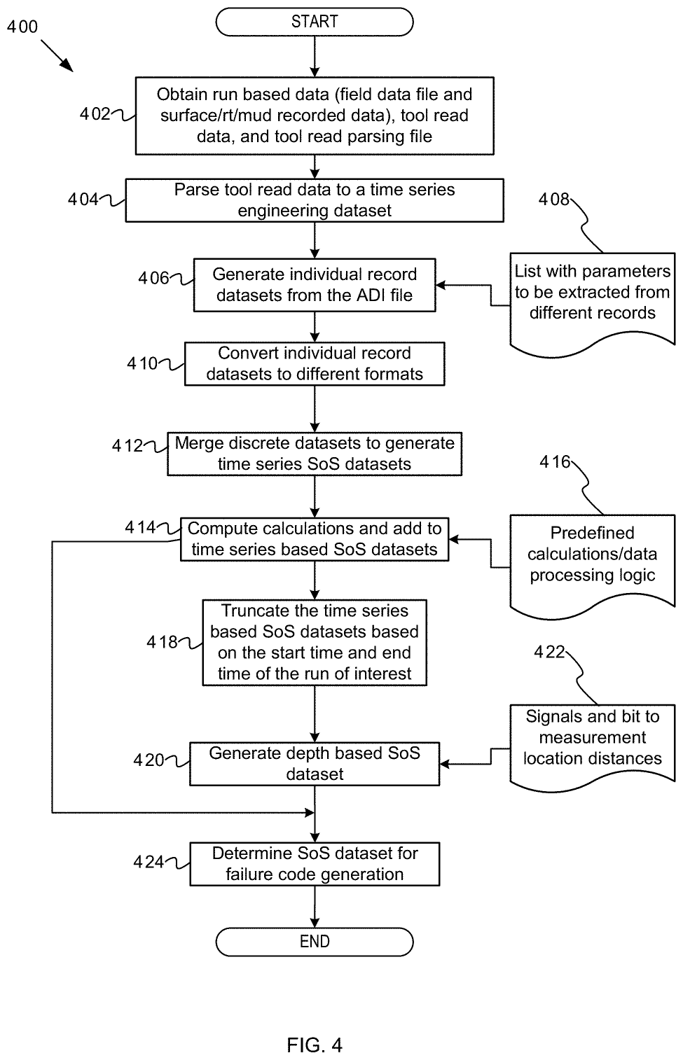

Some of the operations as functions depicted in flowcharts 200 and 300 may also be performed by software, firmware, hardware or a combination thereof of a downhole data processing system and/or a surface data processing system. For example, with reference to FIG. 1, at least some of the operations can be performed by a processor downhole (e.g., integrated into the rotary steerable tool 128) and/or by a processor at the surface executing programmable code. The operations of the flowchart 200 start at block 202 at which an SoS dataset is generated. For example, a standalone application or programmed algorithms integrated with the surface system software can generate an SoS dataset for a downhole tool in time or depth reference at the rig site, and/or at other local or remote processing sites such as at manufacturing and/or repair and maintenance facilities. The SoS dataset may include rig site surface data, real time telemetry data, and downhole recorded data. Example operations for generating an SoS dataset are depicted in FIG. 4, which is further described below.

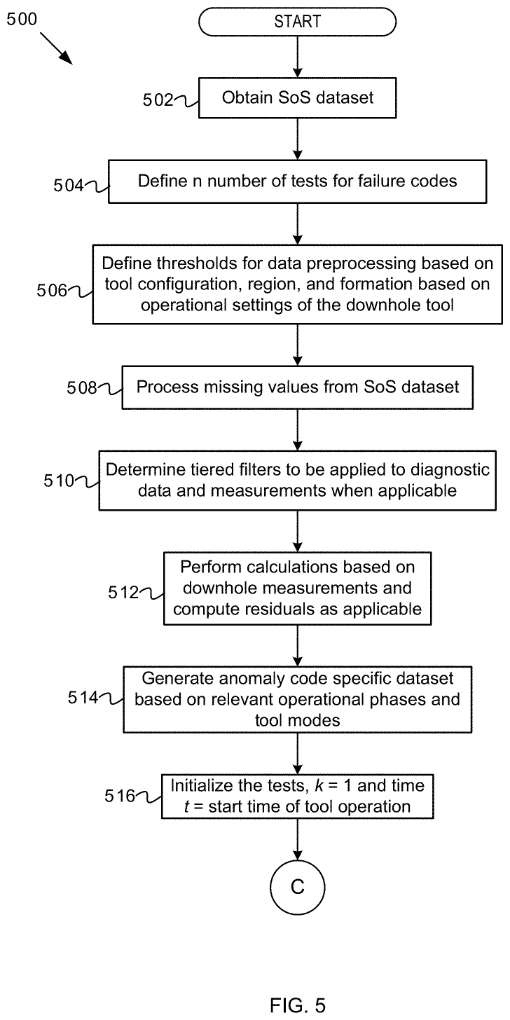

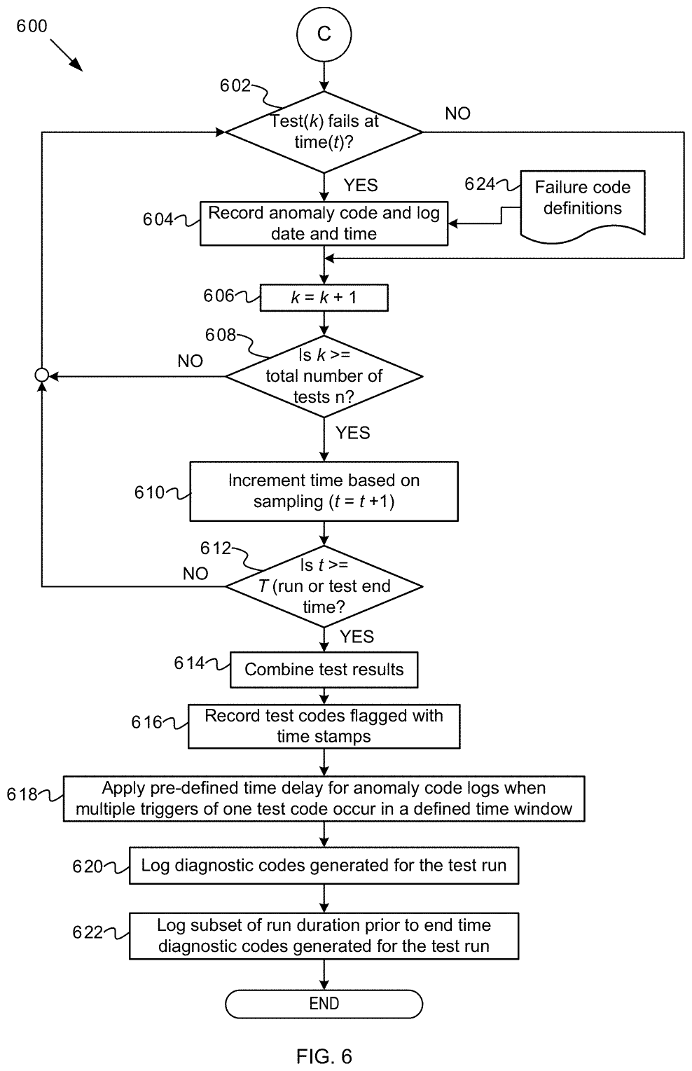

At block 204, anomaly codes are generated by obtaining and processing multi-system information. For example, a standalone application integrated such as by static or dynamic linking with the surface system software may generate the anomaly codes at rig site, manufacturing and/or repair and maintenance facilities. The generated anomaly codes may be multi-level codes that may indicate varying levels of failed or otherwise defective performance such as critical failure codes and non-critical failure codes. The anomaly codes may also include codes that indicate prospective performance issues such as preventive maintenance codes. Example operations for generating anomaly codes are depicted in FIGS. 5-6, which are further described below.

At block 206, a determination is made of whether one or more of the generated anomaly codes is/are critical failure codes. For example, a device with an integrated surface system software processor may identify a generated anomaly code as being a critical failure code by comparing the generated codes with a failure code criticality list 208. In response to determining that a critical failure code has been generated/triggered, operations of the flowchart 200 continue at block 218. In response to determining that a critical failure code has not been generated/triggered, operations of the flowchart 200 continue at block 210.

At block 210, a determination is made of whether one or more of the generated anomaly codes is/are preventive maintenance codes. For example, a device with an integrated surface system software processor can make this determination. For instance, preventive maintenance may be triggered in response to determining that total accumulated collar life has reached its limit based on measurement data within the SoS dataset. In response to determining that a preventative maintenance code has been generated/triggered, operations of the flowchart 200 continue at block 218. In response to determining that a critical failure code has not been generated/triggered, operations of the flowchart 200 continue at block 212.

At block 212, status of the downhole tool is set as continue operation or re-start operation without maintenance. For example, a device with an integrated surface system software processor may set the status of the downhole tool as continuing or re-starting operation. At block 214, a determination is made of whether the downhole tool continues to operate or is re-started. For example, a programmed data processing system by perform this determination based on the failure codes log, tool inspection at surface and/or surface tests. In response to determining that the downhole tool continues or has re-started operation, the operations of the flowchart 200 return to block 202. In response to determining that the downhole tool is not operating, operations continue at block 216.

At block 216, a determination is made of whether one or more of the generated anomaly codes is/are non-critical failure codes. For example, a device with an integrated surface system software processor may identify a generated anomaly code as being a non-critical failure code by comparing the generated codes with failure code criticality list 208. In response to determining that a non-critical failure code has not been generated/triggered, operations of the flowchart 200 continue at transition point A, which continues at transition point A in the flowchart 300 of FIG. 3. In response to determining that a non-critical failure code has been generated/triggered, operations of the flowchart 200 continue at block 218.

At block 218, a fault diagnostics result is generated based on the fault codes logs and a tool fault model. For example, a device with a standalone application or linked modules integrated with the surface system software can make this determination. The tool fault model may be generated based on cause and effect dependencies with the failures (e.g., failures associated with the critical and non-critical failure codes) and the analysis of the failures. In some embodiments, the cause and effect dependencies may be determined using the tool architecture, design documents, simulation, performance history information, etc. Relevant anomaly codes based on BHA and overall drilling system architecture can be defined and added to the fault model enabling the model to identify various systems failures that may result in service interruptions. This combined fault model can be represented as a cause and effect dependency matrix. The anomaly codes generated/triggered at block 204 can be input into the fault model and the device with diagnostic algorithms integrated with the surface system software may generate the diagnostic results. Additional anomaly codes generated during post-run tool testing and maintenance (block 220) can be input to the fault model or other application to generate the fault diagnostics result(s). Post maintenance, a tool level only fault model can be used to perform final quality check to assess the operational condition of the tool before the tool is dispatched to the field to minimize immediate post-implementation failures. Operations of the flowchart 200 continue at transition point B, which continues at transition point B in the flowchart 300 of FIG. 3.

From transition point B, operations continue at block 302 at which anomaly codes and suspects-based specific plots are generated and analyzed. In some embodiments, generating the plots may comprise displaying anomaly information plots on a computer display. Some of the specific plots may display graphical information indicating the environmental and operational stresses experienced by the tool of interest during downhole operation. A library of plot templates for a pre-defined anomaly codes/suspect list and associated program code may be used to enable and automate this functionality. For example, if the anomaly codes include one or more failure codes that indicate overvoltage on a high-power line and the fault model confirms failure on a 400V line, the process may generate a specific plot of 400V measurements at different points, tool state, operational mode, etc. The generated plots may provide insight into the cause of the failure for cases in which multiple causes may potentially result in the same failure triggering the corresponding anomaly code(s). The generated plots may also depict, describe, or otherwise characterize test conditions to be used to replicate the downhole problem at surface, and furthermore may determine false positives due to data quality issues.

At block 304, a determination is made of whether the failures determined by the fault model or otherwise based on the anomaly codes are true or false positives. For example, the plots generated based on a log containing the anomaly codes and corresponding downhole tools associated with the anomaly codes are compared to reference specific plots for correct dispositioning. For instance, if one of more specific plots generated at block 302 depicts overvoltage during steady state drilling operation, and a module generating the overvoltage flag exhibits a fault state, then the logged failure/anomaly is confirmed positive. In response to determining that one or more of the failures/anomalies are false positives, operations of the flowchart 300 continue at block 306 at which level one preventive maintenance is performed. If the determined failures/anomalies are confirmed true positive, operations of the flowchart 300 continue at block 308.

At block 308, corrective maintenance based on guided troubleshooting is performed. For example, a device with standalone application or integrated surface system software can perform this operation. For instance, the failure diagnostics may be a problem on a high-power signal line in the tool. A technician and/or automated repair system may be presented a set of troubleshooting operations that enable isolation of the failure to a replaceable component (e.g., connector at an instrumentation collar) level. In some embodiments, labor and repair costs, skill level, testing time, etc. are accounted for by the device in which a standalone application or integrated surface system software may provide such guided troubleshooting steps.

Operations of the flowchart 300 continue at block 310 at which full tool assembly and checkout is performed. Tool build quality can be confirmed with system level test and diagnostic fault model. At block 312, an inventory is performed, completing the operations of the flowcharts 200 and 300.

In the foregoing manner, the operations depicted in FIGS. 2-3 are implemented to determine accurate operational condition and re-run criteria for one or more downhole tools. If no anomaly codes are flagged, then preventive maintenance (PM) can be performed based on PM triggers. Additionally, if anomaly codes for secondary functions are flagged, the downhole tool could still be re-run without repair if legacy based redundant tools could be used for secondary functions or if service can be delivered without the secondary function, and if no preventive maintenance triggers are flagged for primary or critical functionality. Also, as part of these operations, if anomaly codes for primary or critical functionality are flagged, the tool fault diagnostic results can be updated with post run shop level test observations and troubleshooting guidelines provided.

FIG. 4 depicts a flowchart of operations to generate a System of Systems (SoS) dataset, according to some embodiments. Operations of a flowchart 400 can be automated using algorithms that can be processed by software, hardware or a combination thereof. Operations of the flowchart 400 can be example operations of the operation at block 202 of the flowchart 200 for generating an SoS dataset. At block 402, field run data, tool read data, and tool read parsing files are obtained. The field run based data can include surface data, real time data from downhole tools, downhole tools recorded data, mud logs and other operational data. In addition, there can be memory read data (example: binary files) generated through separate downhole tools memory data read. Parsing files for memory data read are pre-defined based on tools used in the tool string.

At block 404, memory tool read datasets is parsed into a time series engineering dataset. For example, a device with standalone application or an integrated surface system software can parse the tool read data. Data recorded at the tool can be in a binary file format with sensor measurements, tool modes, diagnostic information etc. Such data can be parsed with proper scaling to generate a time series dataset with engineering values of the measurements. The parsed data can be integrated into field data file and/or it can be merged into a SoS dataset using programmable codes executed by the processor.

At block 406, data from different records is extracted from the field data file as different/individual datasets. The field data can contain data in different formats. For example, an algorithm or programmable code executed by the processor—can generate these individual datasets. A list with parameters to be extracted from the different records contained in the field data file (408) can be input for this operation. Surface data, downhole tools real time and recorded data, mud logs and other operational data can be stored as different records in the field data file. Individual dataset records can be generated by extracting defined parameters of interest maintained in a dynamic (editable) list of parameters or variables.

At block 410, the individual record datasets are converted to homogeneous format. For example, an algorithm or programmable code can convert the individual record datasets to a homogeneous format. At block 412, the discrete datasets are merged into time series SoS dataset. For example, programmable code executed by a processor can merge the discrete datasets into time series SoS dataset. At block 414, calculations are computed and added to time series based SoS dataset. For example, an algorithm or programmable code a processor can perform these operations. Predefined calculations based on the parameters/variables already present in the SoS dataset, data processing logic and/or test based, physics-based models at block 416 can be input for this operation. For example, the pressure differential can be calculated from annulus and bore pressure measurements and added to the SOS dataset. Another example can be to compute the downhole flow rate from turbine RPM, mud properties and test-based transfer functions.

At block 418, the time series based SoS datasets are truncated based on the start time and end time for the run of interest. For example, an algorithm or programmable code can perform this truncation. At block 420, a depth based SoS dataset is generated. For example, an algorithm or programmable code can be used to generate the depth based SoS dataset parameters and/or variables and corresponding bit to sensor distance measurements at block 422 can be input for this operation. The SoS dataset is now available in time-based or depth-based reference for analysis. For time-based data, the variables can be populated with their values in increasing chronological time based on the sampling rate. For depth-based data, the variables can be populated with values in increasing depth.

At block 424, an SoS dataset for anomaly code generation is determined. For example, user can determine the SoS dataset to be used for anomaly code generation. In some embodiments, anomaly code generation may require only a subset of the SoS dataset. In addition to SoS dataset, other data such as tool and BHA configuration, operational events etc. can also be extracted and used for performance evaluation, operational procedure/sequencing or optimized state transitions for improved performance, and diagnostics. In the foregoing manner, the operations of flowchart 400 generate a SoS dataset in time and depth domains to be used for diagnostics of downhole tools.

FIGS. 5-6 depict flowcharts of operations to generate anomaly codes, according to some embodiments. Operations of flowcharts 500-600 of FIGS. 5-6 continue among each other through transition point C. Operations of the flowcharts 500-600 can be performed by combination of software and hardware. For example, with reference to FIG. 1, at least some of the operations can be performed by a processor downhole (e.g., integrated into the rotary steerable tool 128) and/or by a processor at the surface executing programmable code. Operations of the flowcharts 500-600 can be example operations of the operation at block 204 of the flowchart 200 for generating anomaly codes. The operations of the flowchart 500 start at block 502.

At block 502, the SoS dataset is obtained. For example, programmable code executing on a processor may obtain the SoS dataset such as by a programmed request executed by a communication interface. At block 504, n number of tests for the anomaly codes are defined. For example, an algorithm or programmable code can define the n number of tests. Tests may entail pass/fail criteria for measurements, estimated parameters based on measurements and various changed detection algorithms suitable for each tests etc.

At block 506, thresholds and conditions for data preprocessing are defined based on downhole tools configuration, region, and formation based operational settings. For example, programmable code executing on a processor may define the thresholds based on operational mode and/or tool mode. Example of tool mode filtering could be passive or active rectification mode, neutral vs geostationary mode etc. Operational modes could entail pumps on/pumps off, drilling activity etc.

At block 508, missing values from the SoS dataset are processed. For example, programmable code executing on a processor may process the missing values. To illustrate, if certain variables have missing values, the processor can determine how to process including replacing with mean, previous values, interpolation, removing the entire sample, etc.

At block 510, tiered filters are applied to diagnostic data and measurements when applicable. For example, programmable code may apply the tiered filters in which there may be multiple layers of filtering. For example, a first filter may be based on flow rate being greater than a flow threshold. A second filter may follow the first filter and may be based on tool mode such as active versus passive rectification.

At block 512, calculations based on downhole measurements and/or test-based/physics-based models are performed and residuals are computed as applicable. For example, programmable code executing on a processor may perform these operations. To illustrate, flow rate can be estimated based on differential pressure, bit total flow area and physics-based model. The residuals can then be computed as applicable.

At block 514, an anomaly code specific dataset is generated based on relevant operational modes/phases and tool modes. For example, programmable code executing on a processor may generate the anomaly code specific dataset. For example, undervoltage fault flag on module 2 high voltage signal is only valid when (1) the module 1 is in active rectification, (2) tool modes downhole, and (3) tool state is hold tool face.

At block 516, the tests are initialized with k equaling one and t equaling start time of the downhole tool. For example, programmable code executing on a processor may initialize the tests by setting these variables to their appropriate values. Operations of the flowchart 500 continue at transition point C, which continues at transition point C of the flowchart 600. From transition point C, operations continue at block 602 in which a determination is made of whether test (k) fails at time (t). For example, a programmable code may make this determination. If the test (k) does not fail at time (t), operations of the flowchart 600 continue at block 606 (which is further described below).

If the test (k) does fail at time (t), operations of the flowchart 600 continue at block 604. At block 604, the anomaly code is recorded (the date and time of the failure is also logged). For example, programmable code executing on a processor may perform these operations. Anomaly code definitions 624 can be input for this operation.

At block 606, the variable k is incremented (k=k+1) such as may be executed by programmable code executing on a processor. At block 608, a determination is made of whether the variable k is greater than the total number of tests, n. If the variable k is not greater than the total number of tests n, operations return to block 602. Otherwise, operations continue at block 610 at which time is incremented based on sampling (t=t+1).

At block 612, a determination is made of whether time t is greater than T (run or test end time), such as may be executed by programmable code executing on a processor. If time t is not greater than T, operations return to block 602. Otherwise, operations continue at block 614. At block 614, the test results are combined, such as may be executed by programmable code executing on a processor. There may be k tests for a given time instant and the tests can be performed for an entire time T Therefore, these tests can be combined for the entire time T. Alternatively, the test k can be tested from start time to the end time T and then k can be incremented by k=k+1. The test results may be combined.

At block 616, anomaly codes flagged with timestamps are recorded, such as may be executed by programmable code executing on a processor. Thus, the anomaly codes are associated with a time of occurrence. At block 618, a pre-defined time delay for anomaly code logs is applied when multiple triggers of one test code occur in pre-defined time window. For example, if a failure continues to occur, instead of recording every instant, the programmable code applies pre-defined time delay. To illustrate, if failure happens every second, for 30 minutes there would be 1800 records of the same fault without any time delay. Instead of logging 1800 records, a time delay is applied. For example, if a fault is logged, logging is delayed over the next 5 minutes even if otherwise triggered within the 5 minute period.

At block 620, diagnostic codes generated for the test run are logged, such as may be executed by programmable code executing on a processor. At block 622, fault codes observed during the entire test time duration is logged. For example, an algorithm or programmable code can perform this operation. Along with anomaly codes log, end of run failure logs can be logged separately. An end of run failure log can be generated to provide a more precise characterization of the failure that caused a condition requiring withdrawal of drill string components from the borehole in addition to a more comprehensive characterization of the entire run log. In the foregoing manner, flowcharts 500 and 600 include operations to generate anomaly codes and observations that can be pre-defined for a system of interest using an SoS dataset. The anomaly code log may then be leveraged for diagnostics and guided troubleshooting.

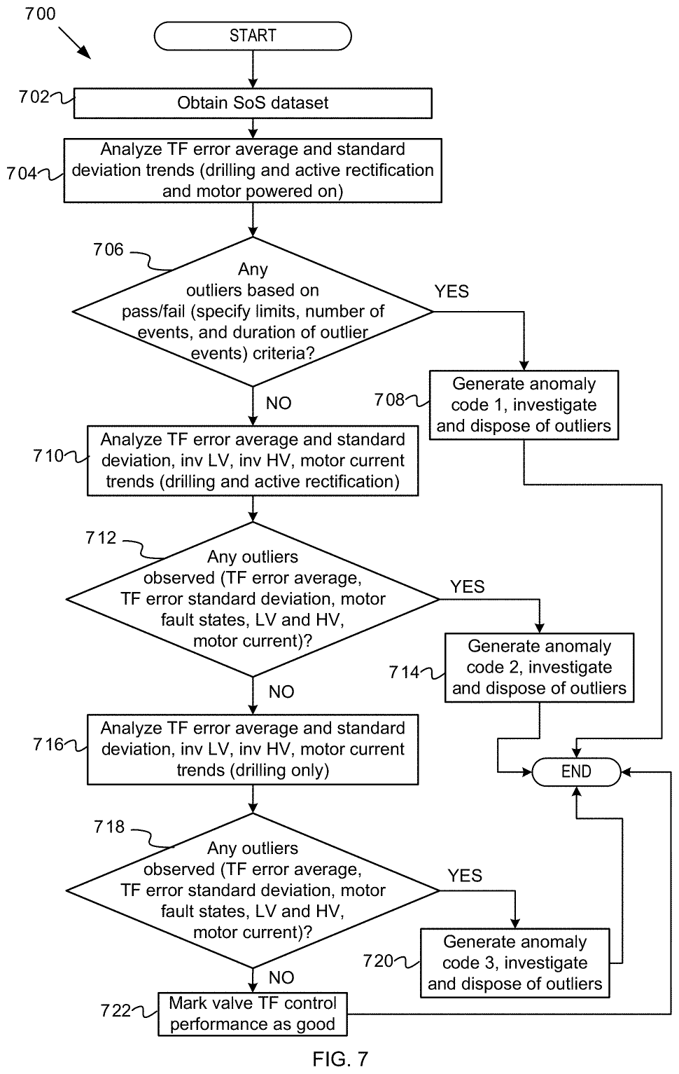

FIG. 7 depicts a flowchart of operations to generate anomaly codes based on tiered filtering, according to some embodiments. Operations of flowchart 700 can be a different example of operations at blocks 302, 510, and 514 of the flowcharts 300 and 500. Operations of the flowchart 700 can be performed by software, firmware, hardware, or a combination thereof. For example, with reference to FIG. 1, at least some of the operations can be performed by a processor downhole (e.g., integrated into the rotary steerable tool 128) and/or by a processor at the surface executing programmable code.

The operations of the flowchart 700 start at block 702 at which the SoS dataset is obtained. For example, programmable code executing on a processor may obtain the SoS dataset such as by a programmed request executed by a communication interface. At block 704, TF error average and standard deviation trends are analyzed while drilling, in active rectification, and with motor on state. An algorithm or programmable code can perform this operation. For example, the analysis can include how toolface error average and standard deviation are changing over time and how they compare to predefined control limits (increasing, remaining constant, decreasing, fluctuating between an increase and decrease, etc.). Anomaly codes 1, 2, and 3 in FIG. 7 are derived from the same set of measurements (TF error average and standard deviation) with different/tiered filtering applied.

At block 706, a determination is made of whether there are any outliers based on pass/fail criteria (specified upper and lower limits, number of events, and duration of outlier events), such as may be performed by programmable code executing on a processor. For example, based on design documents, operations, and testing, limits and ranges of different measurements for various tool modes and operational modes can be defined. Such limits, ranges, and thresholds can be used to determine whether a test has passed or failed. If there are not any outliers, operations of the flowchart 700 continue at block 710.

Otherwise, operations continue at block 708, at which anomaly code 1 is generated and outliers are investigated and disposed, such as may be performed by programmable code executing on a processor. The anomaly code 1 may be part of an input to the fault model for further analysis, and plots from the defined plot library or new plots can be automatically generated and used for dispositioning of the faults. A determination can be made of whether these are legitimate faults or false alarms.

At block 710, TF error average and standard deviation and other relevant signals trends are analyzed while drilling and in active rectification mode only, such as may be performed by programmable code executing on a processor. At block 712, a determination is made whether there are any outliers observed (TF error average, TF error standard deviation, and other relevant signals), such as may be performed by programmable code executing on a processor. If there are not any outliers, operations of the flowchart 700 continue at block 716.

Otherwise, operations of the flowchart 700 continue at block 714 at which anomaly code 2 is generated and outliers are investigated and disposed, such as may be performed by programmable code executing on a processor. The anomaly code 2 may be included in an input to the fault model for further analysis, and plots from the defined plot library or new plots may be automatically generated and used for dispositioning of the faults.

At block 716, TF error average and standard deviation and other relevant signals are analyzed while drilling only. At block 718, a determination is made whether there are any outliers observed (TF error average, TF error standard deviation, and other relevant signals). For example, an algorithm or programmable code can make this determination. If there are no outliers, operations of the flowchart 700 continue at block 722 (which is further described below). Otherwise, operations of the flowchart 700 continue at block 720.

At block 720, anomaly code 3 is generated and outliers are investigated and disposed. For example, an algorithm or programmable code can perform these operations. The anomaly code 3 can be part of an input to the fault model for further analysis, and plots from the defined plot library or new plots can be automatically generated and used for dispositioning of the faults. At block 722, valve TF control performance is marked as good. For example, an algorithm or programmable code can perform this operation. In the foregoing manner, flowchart 700 includes operations to flag anomaly codes using different or tiered filtering of the same signal to help narrow the fail site isolation region to be used for diagnosis of downhole tools.

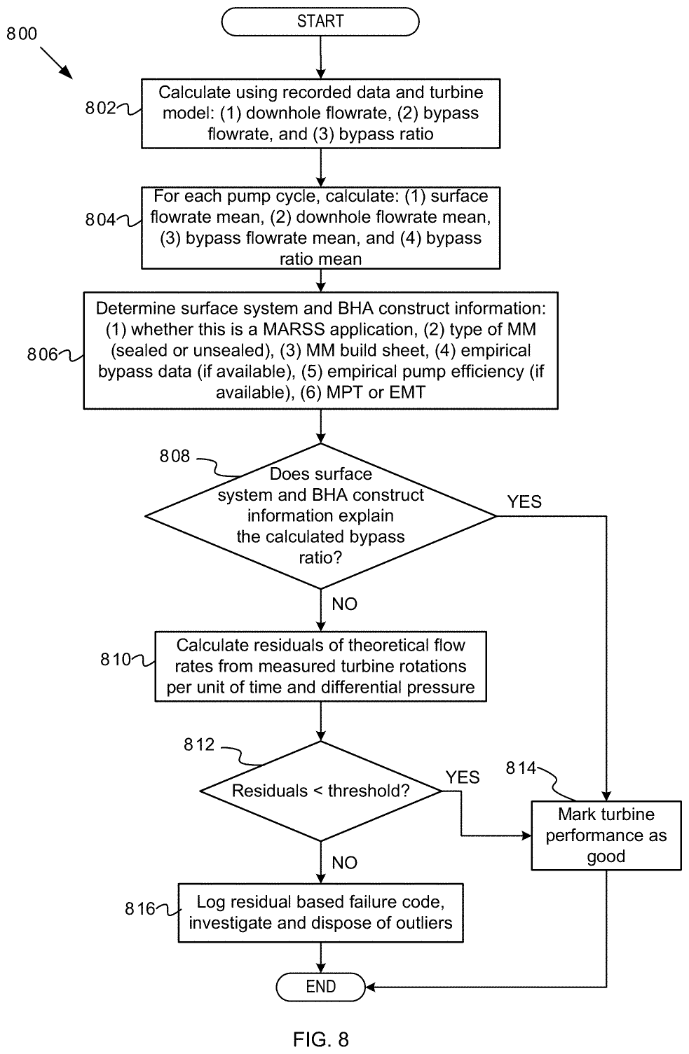

FIG. 8 depicts a flowchart of operations to flag anomaly codes based on residuals, according to some embodiments. Operations of flowchart 800 can be a different example of operations at blocks 302, 512 and 514 of the flowcharts 300 and 500. Operations of the flowchart 800 can be performed by software, firmware, hardware or a combination thereof. For example, with reference to FIG. 1, at least some of the operations can be performed by a processor downhole (e.g., integrated into the rotary steerable tool 128) and/or by a processor at the surface executing programmable code.

At block 802, downhole flowrate to the turbine, bypass flowrate to the annulus, and bypass ratio are calculated based on turbine speed recorded data, surface flow rate data and a turbine model. The bypass flowrate depends on the BHA configuration and drill pipe integrity while drilling. At block 804, under steady state conditions a surface flowrate mean, a downhole flowrate mean, a bypass flowrate mean, and a bypass ratio mean are calculated for each pump cycle. Moving average calculations could also be used, such as may be performed by programmable code executing on a processor.

At block 806, surface system and BHA construct information is determined. For example, an algorithm or programmable code can make this determination. This information can include (1) whether this is a MARSS (motor assisted rotary steerable drilling) application, (2) type of mud motor (sealed or unsealed), (3) mud motor build sheet, (4) empirical bypass data (if available), (5) empirical pump efficiency (if available), and (6) mud pulse telemetry (MPT) or electromagnetic telemetry (EMT).

At block 808, a determination is made whether the surface system and BHA construct information are logically consistent with the calculated bypass ratio. If the surface system and BHA construct information is consistent with the calculated bypass ratio, operations of the flowchart 800 continue at block 814, which is further described below. Otherwise, operations of the flowchart 800 continue at block 810 at which downhole flowrate2 is computed based on differential pressure recorded data and a hydraulic model. Also residual of flow rates (difference between measured flowrate at surface and estimated flowrate using turbine model along with downhole measurements of turbine speed (revolutions per minute (RPM)) and differential pressure) is calculated.

At block 812, a determination is made of whether the residual is less than a threshold. If the residual is not less than a threshold, operations of the flowchart 800 continue at block 816, which is further described below. Otherwise, operations of the flowchart 800 continue at block 814 at which turbine performance is classified as acceptable. At block 816, a residual based anomaly code is logged and outliers are investigated and disposed. In the foregoing manner, flowchart 800 includes operations to flag anomaly codes using residuals of theoretically estimated measurements, wherein the anomaly codes can be used for diagnostics of downhole tools.

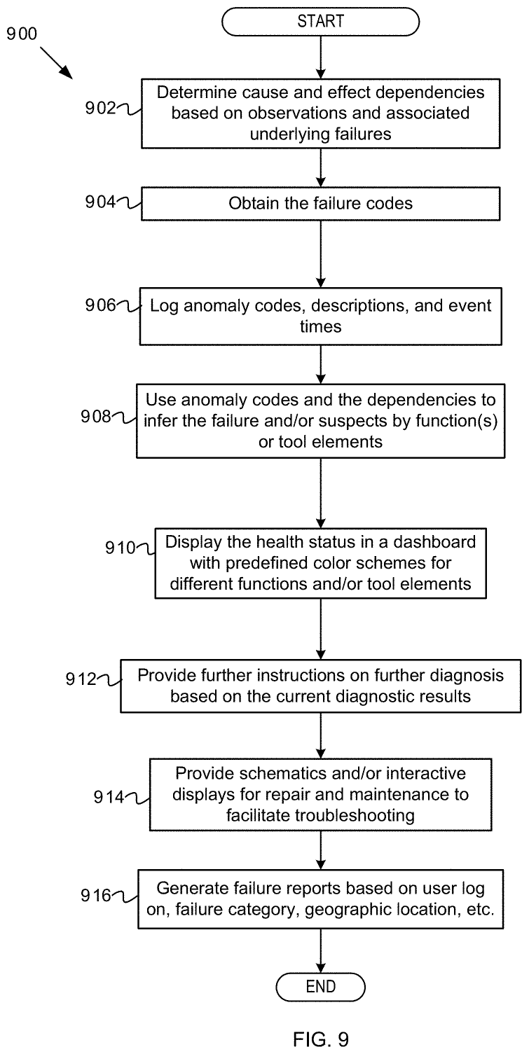

FIG. 9 depicts a flowchart of operations for RSS diagnostics, according to some embodiments. Operations of a flowchart 900 can be performed by software, firmware, hardware or a combination thereof. For example, with reference to FIG. 1, at least some of the operations can be performed by a processor at the surface executing programmable code or an integrated surface software. At least a portion of the operations of the flowchart 900 can be example operations of the operation at block 218 of flowchart 200 for generating the tool fault model. The operations of flowchart 900 starts at block 902.

At block 902, cause and effect dependencies are determined based on observations and associated underlying failures. In some embodiments, this determination can be made when the system is designed and developed. During product development, a model of failures and their observations can be built using various design documents, experiments, data analysis, performance history information, dFMEA, BHA configurations based of field use cases, enabling systems used etc.

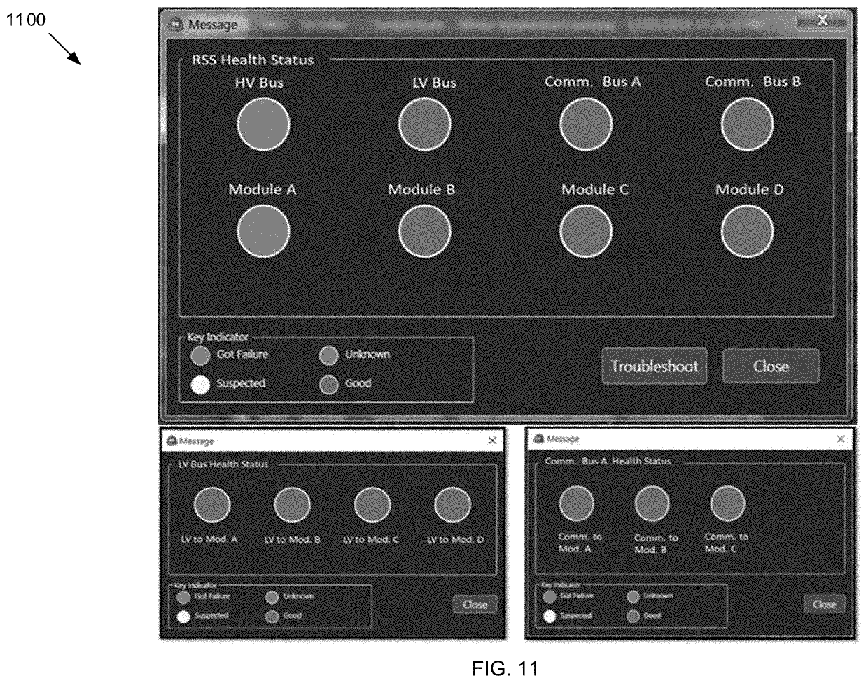

At block 904, anomaly codes are obtained based on the flowchart shown in FIG. 6 for a SoS dataset. At block 906, anomaly codes, descriptions, and event times are logged in chronological order. The log can be queried for specific anomaly codes. An example of a display of such logging is depicted in FIG. 11, which is further described below. At block 908, anomaly code log and the fault model are used to infer the failure and/or suspects by function(s) or tool elements. The fault model developed at block 902 along with the anomaly codes log generated at block 904 can be used to infer and display the failure and/or suspects. The failure/suspects can be classified based on functions and/or by tool elements.

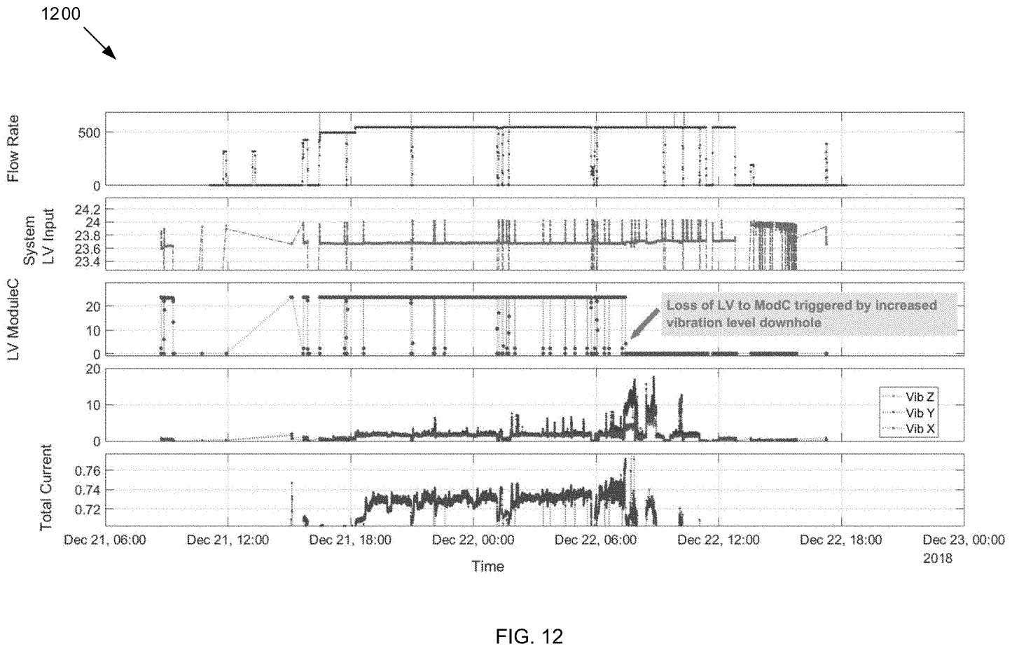

At block 910, the operational status or health status is displayed in a dashboard with predefined color schemes (red for confirmed failures, yellow for suspects, green for no failures and grey for unknown fault status) for different functions and/or tool elements. For example, a processor can perform this operation. Once the failure and/or suspects are inferred based on functions and/or tool elements, the failures and/or suspects can be presented in a dashboard. An example of such a dashboard is depicted in FIG. 12 (which is further described below).

At block 912, instructions on further isolation are provided based on the current diagnostic results. Based on results from the cause and effect dependencies and tool fault model, further available tests (e.g., tests performed at a repair or maintenance facility) can be performed to isolate the failure to a lower level (e.g., component level). Such instructions include overall system schematics and fault location, further necessary tests to isolate/confirm the failure in suitable interactive form the user.

At block 914, schematics and/or interactive displays are provided for repair and maintenance to facilitate troubleshooting. For example, based on the diagnostic results generated by operations at block 910, a fault specific and tailored schematic and/or interactive display can be presented. At block 916, failure reports are generated based on user login records, failure category, geographic locations, etc. For example, information about user logins, failure category, geographic location, etc. may be combined for various jobs or runs to extract customized reports.

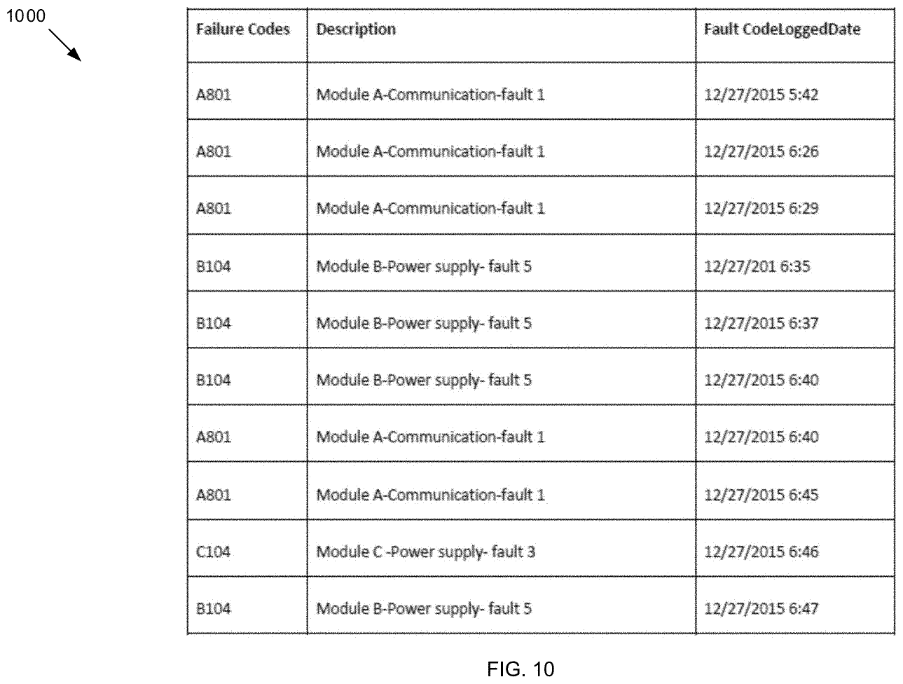

FIG. 10 depicts a list of example anomaly codes, according to some embodiments. In particular, FIG. 10 depicts a list 1000 with three columns—failure code identification, description, and time.

FIG. 11 depicts an example Graphical User Interface (GUI) of failure/suspect isolation based on example anomaly codes illustrated in FIG. 10, according to some embodiments. In particular, FIG. 11 depicts a GUI 1100 to that may facilitate isolation of failures and potential failure conditions.

FIG. 12, depicts example plots based on the example anomaly codes illustrated in FIG. 10 and displayed in the GUI 100 of FIG. 11, according to some embodiments. In particular, FIG. 12 depicts plots 1200. The plots 1200 include relevant signals based on anomaly codes and suspect list for guided troubleshooting.

### Example Computer

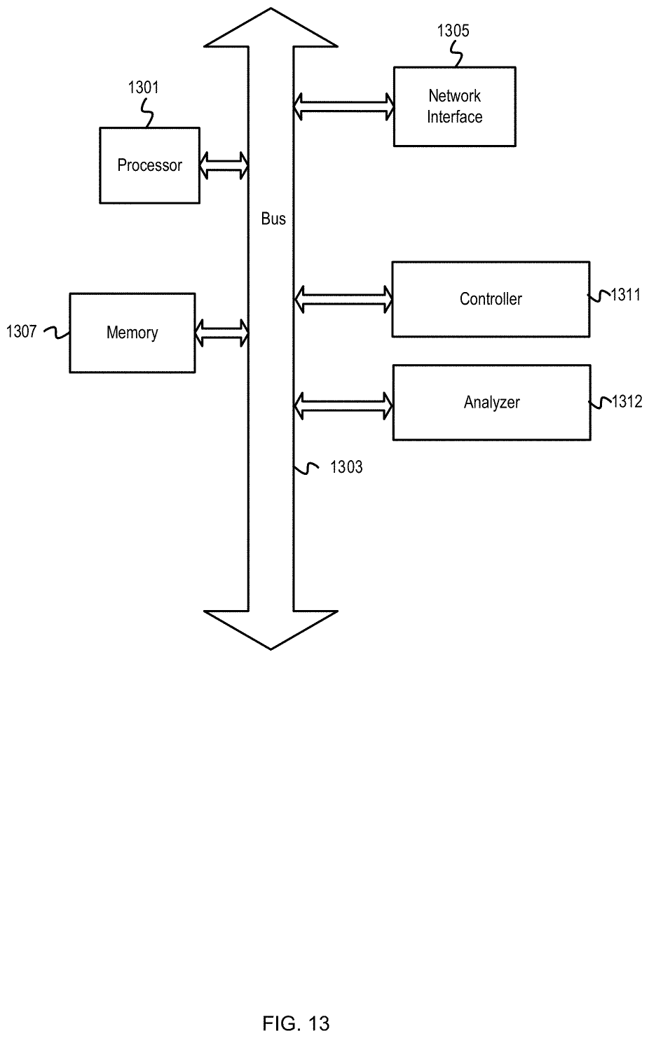

FIG. 13 depicts an example computer, according to some embodiments. The computer includes a processor 1301 (possibly including multiple processors, multiple cores, multiple nodes, and/or implementing multi-threading, etc.). The computer includes memory 1307. The memory 1307 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 1303 (e.g., PCI, ISA, PCI-Express, HyperTransport® bus, InfiniBand® bus, NuBus, etc.) and a network interface 1305 (e.g., a Fiber Channel interface, an Ethernet interface, an internet small computer system interface, SONET interface, wireless interface, etc.).

The computer also includes an analyzer 1311 and a controller 1315. The analyzer 1311 can perform diagnostic operations of a downhole tool (as described above). The controller 1312 can control the different operations that can occur in the response to results from the diagnostic operations. For example, the controller 1312 can communicate instructions to the appropriate equipment, devices, etc. to alter different hydrocarbon recovery operations. Any one of the previously described functionalities may be partially (or entirely) implemented in hardware and/or on the processor 1301. For example, the functionality may be implemented with an application specific integrated circuit, in logic implemented in the processor 1301, in a co-processor on a peripheral device or card, etc. Further, realizations may include fewer or additional components not illustrated in FIG. 13 (e.g., video cards, audio cards, additional network interfaces, peripheral devices, etc.). The processor 1301 and the network interface 1305 are coupled to the bus 1303. Although illustrated as being coupled to the bus 1303, the memory 1307 may be coupled to the processor 1301.

As will be appreciated, aspects of the disclosure may be embodied as a system, method, or program code/instructions stored in one or more machine-readable medium(s). Accordingly, aspects may take the form of hardware, software (including firmware, resident software, micro-code, etc.), or a combination of software and hardware aspects that may all generally be referred to herein as a “circuit,” “module,” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine-readable storage medium. A machine-readable storage medium may be, for example, but not limited to, a system, apparatus, or device that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device. Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C#, C++; or like a dynamic programming language such as Python; or like a high level programming language for technical computing such as MATLAB®; a scripting language such as Perl programming language or PowerShell script language; and conventional procedural programming languages, such as the C programming language or similar programming languages. The program code may execute entirely on a standalone machine, may execute in a distributed manner across multiple machines, and may execute on one machine while providing results and or accepting input on another machine. The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus. As used herein, the term “or” is inclusive unless otherwise explicitly noted. Thus, the phrase “at least one of A, B, or C” is satisfied by any element from the set {A, B, C} or any combination thereof, including multiples of any element.

### EXAMPLE EMBODIMENTS

### Embodiment 1

A method comprising: generating a System of Systems (SoS) dataset in a time domain and a depth domain for a downhole tool, wherein the SoS dataset comprises operational data associated with operational modes, tool data associated with tool modes of the downhole tool, and operational data for one or more enabling systems; generating one or more anomaly codes based on the SoS dataset, wherein the anomaly codes correspond to one or more anomalies associated with the downhole tool or an enabling system of the downhole tool; generating a tool fault model based on dependencies of conditions corresponding to the one or more anomaly codes to tool failures or enabling system failures; and determining one or more failures of the downhole tool and one or more causes of the failures based on the tool fault model and the one or more anomaly codes. Said generating the one or more anomaly codes may comprise generating the anomaly codes based on a tiered filtering of the SOS dataset. Said generating the one or more anomaly codes may comprise generating the anomaly codes based, at least in part, on residuals of predicted operational data. The method of Embodiment 1 may further comprise determining whether at least one anomaly of the one or more anomalies is due to the downhole tool or a system that includes the downhole tool; and isolating a cause of the at least one anomaly based, at least in part, on said determining whether the at least one anomaly is due to the downhole tool or a system that includes the downhole tool. Said isolating a cause of the at least one anomaly may comprise determining that at least one anomaly of the one or more anomalies is a critical failure, and confirming at least one of the generated anomaly codes based, at least in part, on one or more plots generated based on the generated anomaly codes and systems corresponding to the anomaly codes. The method of Embodiment 1 may further comprise using the anomaly codes and the determined one or more failures to determine an initial test to be conducted; and sequencing subsequent tests based on test outcomes and fault trees until one or more failing components are identified. The method of Embodiment 1 may further comprise, in response determining that at least one anomaly of the one or more anomalies is not a critical failure, continuing operation or re-starting operation of the downhole tool. The method of Embodiment 1 may further comprise utilizing the SoS dataset and the generated anomaly codes to modify at least one of operational procedures and tool state transition logic.

### Embodiment 2

A system comprising: a downhole tool configured to be positioned in a borehole, the downhole tool comprising a number of sensors configured to detect events related to operation of the downhole tool; and a diagnostics device configured to generate a System of Systems (SoS) dataset in a time domain and a depth domain for a downhole tool, wherein the SoS dataset comprises operational data associated with operational modes, tool data associated with tool modes of the downhole tool, and operational data for enabling systems; generate one or more anomaly codes based on the SoS dataset, wherein the anomaly codes correspond to one or more anomalies associated with the downhole tool or an enabling system of the downhole tool; generate a tool fault model based on dependencies of conditions corresponding to the one or more anomaly codes to tool failures or enabling system failures; and determine one or more failures of the downhole tool and one or more causes of the failures based on the tool fault model and the one or more anomaly codes. Said generating the one or more anomaly codes may comprise generating the anomaly codes based on a tiered filtering of the SoS data. Said diagnostic device may be configured to determine whether at least one anomaly of the one or more anomalies is due to the downhole tool or a system that includes the downhole tool; and isolate a cause of the at least one anomaly based, at least in part, on said determining whether the at least one anomaly is due to the downhole tool or a system that includes the downhole tool. Said diagnostic device may be configured to determine whether the at least one anomaly is a critical failure; and confirm at least one of the generated anomaly codes based, at least in part, on one or more plots generated based on the generated anomaly codes and systems corresponding to the anomaly codes. Said diagnostic device may be configured to utilize combined data from the SoS dataset and from the generated anomaly codes to modify at least one of operational procedures and tool state transition logic.

### Embodiment 3

A machine-readable medium having instructions stored thereon that are executable by a device to perform a method comprising: generating a System of Systems (SoS) dataset in a time domain and a depth domain for a downhole tool, wherein the SoS dataset comprises operational data associated with operational modes, tool data associated with tool modes of the downhole tool, and operational data for enabling systems; generating one or more anomaly codes based on the SoS dataset, wherein the anomaly codes correspond to one or more anomalies associated with the downhole tool or an enabling system of the downhole tool; generating a tool fault model based on dependencies of conditions corresponding to the one or more anomaly codes to tool failures and enabling system failures; and determining one or more failures of the downhole tool and one or more causes of the failures based on the tool fault model and the one or more anomaly codes. For Embodiment 3, the method may further comprise generating the one or more anomaly codes based on a tiered filtering of the SoS data. For Embodiment 3, the method may further comprise determining whether at least one anomaly of the one or more anomalies is due to the downhole tool or a system that includes the downhole tool; and isolating a cause of the at least one anomaly based, at least in part, on said determining whether the at least one anomaly is due to the downhole tool or a system that includes the downhole tool. Said isolating a cause of the at least one anomaly may comprise determining that at least one anomaly of the one or more anomalies is a critical failure; and confirming at least one of the generated anomaly codes based, at least in part, on one or more plots generated based on the generated anomaly codes and systems corresponding to the anomaly codes. Said generating the one or more anomaly codes may comprise generating the anomaly codes based, at least in part, on residuals of predicted operational data. For Embodiment 3, the method may further comprise, in response determining that the failure is not a critical failure, continuing operation or re-starting operation of the downhole tool. For Embodiment 3, the method may further comprise utilizing combined data from the SoS dataset and from the generated anomaly codes to modify at least one of operational procedures and tool state transition logic.

What is claimed is:

1. A method comprising:
generating a System of Systems (SoS) dataset in a time domain and a depth domain for a downhole tool, wherein the SoS dataset comprises operational data associated with operational modes, tool data associated with tool modes of the downhole tool, and operational data for one or more enabling systems;
generating one or more anomaly codes based on the SoS dataset, wherein the anomaly codes correspond to one or more anomalies associated with the downhole tool or an enabling system of the downhole tool;
generating a tool fault model based on dependencies of conditions corresponding to the one or more anomaly codes to tool failures or enabling system failures; and
determining one or more failures of the downhole tool and one or more causes of the failures based on the tool fault model and the one or more anomaly codes.

2. The method of claim 1, wherein said generating the one or more anomaly codes comprises generating the anomaly codes based on a tiered filtering of the SOS dataset.

3. The method of claim 1, wherein said generating the one or more anomaly codes comprises generating the anomaly codes based, at least in part, on residuals of predicted operational data.

4. The method of claim 1, further comprising:
determining whether at least one anomaly of the one or more anomalies is due to the downhole tool or a system that includes the downhole tool; and
isolating a cause of the at least one anomaly based, at least in part, on said determining whether the at least one anomaly is due to the downhole tool or a system that includes the downhole tool.

5. The method of claim 4, wherein said isolating a cause of the at least one anomaly comprises:
determining that at least one anomaly of the one or more anomalies is a critical failure; and
confirming at least one of the generated anomaly codes based, at least in part, on one or more plots generated based on the generated anomaly codes and systems corresponding to the anomaly codes.

6. The method of claim 1, further comprising:
using the anomaly codes and the determined one or more failures to determine an initial test to be conducted; and
sequencing subsequent tests based on test outcomes and fault trees until one or more failing components are identified.

7. The method of claim 1, further comprising, in response determining that at least one anomaly of the one or more anomalies is not a critical failure, continuing operation or re-starting operation of the downhole tool.

8. The method of claim 1, further comprising utilizing the SoS dataset and the generated anomaly codes to modify at least one of operational procedures and tool state transition logic.

9. A system comprising:
a downhole tool configured to be positioned in a borehole, the downhole tool comprising a number of sensors configured to detect events related to operation of the downhole tool; and
a diagnostics device configured to,
generate a System of Systems (SoS) dataset in a time domain and a depth domain for a downhole tool, wherein the SoS dataset comprises operational data associated with operational modes, tool data associated with tool modes of the downhole tool, and operational data for enabling systems;
generate one or more anomaly codes based on the SoS dataset, wherein the anomaly codes correspond to one or more anomalies associated with the downhole tool or an enabling system of the downhole tool;
generate a tool fault model based on dependencies of conditions corresponding to the one or more anomaly codes to tool failures or enabling system failures; and
determine one or more failures of the downhole tool and one or more causes of the failures based on the tool fault model and the one or more anomaly codes.

10. The system of claim 9, wherein said generating the one or more anomaly codes comprises generating the anomaly codes based on a tiered filtering of the SoS data.

11. The system of claim 9, wherein said diagnostic device is configured to:
determine whether at least one anomaly of the one or more anomalies is due to the downhole tool or a system that includes the downhole tool; and
isolate a cause of the at least one anomaly based, at least in part, on said determining whether the at least one anomaly is due to the downhole tool or a system that includes the downhole tool.

12. The system of claim 11, wherein said diagnostic device is configured to:
determine whether the at least one anomaly is a critical failure; and
confirm at least one of the generated anomaly codes based, at least in part, on one or more plots generated based on the generated anomaly codes and systems corresponding to the anomaly codes.

13. The system of claim 9, wherein said diagnostic device is configured to utilize combined data from the SoS dataset and from the generated anomaly codes to modify at least one of operational procedures and tool state transition logic.

14. A machine-readable medium having instructions stored thereon that are executable by a device to perform a method comprising:
generating a System of Systems (SoS) dataset in a time domain and a depth domain for a downhole tool, wherein the SoS dataset comprises operational data associated with operational modes, tool data associated with tool modes of the downhole tool, and operational data for enabling systems;
generating one or more anomaly codes based on the SoS dataset, wherein the anomaly codes correspond to one or more anomalies associated with the downhole tool or an enabling system of the downhole tool;
generating a tool fault model based on dependencies of conditions corresponding to the one or more anomaly codes to tool failures and enabling system failures; and
determining one or more failures of the downhole tool and one or more causes of the failures based on the tool fault model and the one or more anomaly codes.

15. The machine-readable medium of claim 14, wherein the method further comprises generating the one or more anomaly codes based on a tiered filtering of the SoS data.

16. The machine-readable medium of claim 14, wherein the method further comprises:
determining whether at least one anomaly of the one or more anomalies is due to the downhole tool or a system that includes the downhole tool; and
isolating a cause of the at least one anomaly based, at least in part, on said determining whether the at least one anomaly is due to the downhole tool or a system that includes the downhole tool.

17. The machine-readable medium of claim 16, wherein said isolating a cause of the at least one anomaly comprises:
determining that at least one anomaly of the one or more anomalies is a critical failure; and
confirming at least one of the generated anomaly codes based, at least in part, on one or more plots generated based on the generated anomaly codes and systems corresponding to the anomaly codes.

18. The machine-readable medium of claim 14, wherein said generating the one or more anomaly codes comprises generating the anomaly codes based, at least in part, on residuals of predicted operational data.

19. The machine-readable medium of claim 14, wherein the method further comprises, in response determining that the failure is not a critical failure, continuing operation or re-starting operation of the downhole tool.

20. The machine-readable medium of claim 14, wherein the method further comprises utilizing combined data from the SoS dataset and from the generated anomaly codes to modify at least one of operational procedures and tool state transition logic.
